(19) United States
(12) Patent Application Publication
(10) Pub. No.: US 2006/0039400 A1
(43) Pub. Date: Feb. 23, 2006

(54) Pause frame reconciliation in end-to-end and local flow control for ethernet over sonet

(76) Inventors: Suvhasis Mukhopadhyay, Shrewsbury, MA (US); Pushkal Yadav, New Delhi (IN); Neil Singer, Lexington, MA (US); Ramakrishnan Shankar, New Delhi (IN)

Correspondence Address: Gordon & Jacobson, P.C., 65 Woods End Road, Stamford, CT, 06905, US

(21) Appl. No.: 10/924,039

(22) Filed: Aug. 23, 2004

(51) Int. Cl. H04L 12/413

(52) U.S. Cl. 370/447

(57) ABSTRACT

Whenever a PAUSE frame is generated locally, a pause refresh timer is set with the pause parameter from the PAUSE frame. PAUSE frames which are received from a remote data sink are trapped and the value of the pause parameter is evaluated. If the value is smaller than the current pause refresh timer value, the pause frame is discarded. If the value is equal to or larger than the current pause refresh timer value, the PAUSE frame is passed on to the data source and an end-to-end flow control (EEFC) timer is set with the pause parameter received from the remote data sink. While the EEFC timer is counting down, locally generated PAUSE frames having a pause parameter less than the timer value are suppressed.

### BACKGROUND OF THE INVENTION

1. Field of the Invention

This invention relates broadly to transmitting ETHERNET signals over SONET telecommunications connections. More particularly, this invention relates to reconciling local and end-to-end flow control for ETHERNET over SONET.

2. State of the Art

The Synchronous Optical Network (SONET) or the Synchronous Digital Hierarchy (SDH), as it is known in Europe, is a common telecommunications transport scheme which is designed to accommodate both DS-1 (T1) and E1 traffic as well as multiples (DS-3 and E-3) thereof. A DS-1 signal consists of up to twenty-four time division multiplexed DS-0 signals plus an overhead bit. Each DS-0 signal is a 64 kb/s signal and is the smallest allocation of bandwidth in the digital network, i.e. sufficient for a single telephone connection. An E1 signal consists of up to thirty-two time division multiplexed DS-0 signals with at least one of the DS-0s carrying overhead information.

Developed in the early 1980s, SONET has a base (STS-1) rate of 51.84 Mbit/sec in North America. The STS-1 signal can accommodate 28 DS-1 signals or 21 E1 signals or a combination of both. The basic STS-1 signal has a frame length of 125 microseconds (8,000 frames per second) and is organized as a frame of 810 octets (9 rows by 90 byte-wide columns). It will be appreciated that 8,000 frames*810 octets per frame*8 bits per octet=51.84 Mbit/sec. The frame includes the synchronous payload envelope (SPE) or virtual container (VC) as it is known in Europe, as well as transport overhead. Transport overhead is contained in the first three columns (27 bytes) and the SPE/VC occupies the remaining 87 columns.

In Europe, the base (STM-1) rate is 155.520 Mbit/sec, equivalent to the North American STS-3 rate (3*51.84=155.520). The STS-3 (STM-1) signals can accommodate 3 DS-3 signals or 63 E1 signals or 84 DS-1 signals, or a combination of them. The STS-12 signals are 622.080 Mbps and can accommodate 12 DS-3 signals, etc. The STS-48 signals are 2,488.320 Mbps and can accommodate 48 DS-3 signals, etc. The highest defined STS signal, the STS-768, is nearly 40 Gbps (gigabits per second). The abbreviation STS stands for Synchronous Transport Signal and the abbreviation STM stands for Synchronous Transport Module. STS-n signals are also referred to as Optical Carrier (OC-n) signals when transported optically rather than electrically.

To facilitate the transport of lower-rate digital signals, the SONET standard uses sub-STS payload mappings, referred to as Virtual Tributary (VT) structures. (The ITU calls these structures Tributary Units or TUs.) This mapping divides the SPE (VC) frame into seven equal-sized sub-frames or VT (TU) groups with twelve columns of nine rows (108 bytes) in each. Four virtual tributary sizes are defined as follows.

VT1.5 has a data transmission rate of 1.728 Mb/s and accommodates a DS1 signal with overhead. The VT1.5 tributary occupies three columns of nine rows, i.e. 27 bytes. Thus, each VT Group can accommodate four VT1.5 tributaries.

VT2 has a data transmission rate of 2.304 Mb/s and accommodates a CEPT-1 (E1 ) signal with overhead. The VT2 tributary occupies four columns of nine rows, i.e. 36 bytes. Thus, each VT Group can accommodate three VT2 tributaries.

VT3 has a data transmission rate of 3.456 Mb/s) and accommodates a DS1C (T2) signal with overhead. The VT3 tributary occupies six columns of nine rows, i.e. 54 bytes. Thus, each VT Group can accommodate two VT3 tributaries.

VT6 has a data transmission rate of 6.912 Mb/s and accommodates a DS2 signal with overhead. The VT6 tributary occupies twelve columns of nine rows, i.e. 108 bytes. Thus, each VT Group can accommodate one VT6 tributary.

As those skilled in the art will appreciate, the original SONET/SDH scheme as well as the VT mapping schemes were designed to carry known and potentially foreseeable TDM (time division multiplexed) signals. In the early 1980s these TDM signals were essentially multiplexed telephone lines, each having the (now considered) relatively small bandwidth of 56-64 kbps. At that time, there was no real standard for data communication. There were many different schemes for local area networking and the wide area network which eventually became known as the Internet was based on a “56 kbps backbone”. Since then, ETHERNET has become the standard for local area networking. Today ETHERNET is available in four bandwidths: the original 10 Mbps system, 100 Mbps Fast ETHERNET (IEEE 802.3u), 1,000 Mbps Gigabit ETHERNET (IEEE 802.3z/802.3ab), and 10 Gigabit ETHERNET (IEEE 802.3ae).

In recent years it has been recognized that SONET/SDH is the most practical way to link high speed ETHERNET networks over a wide area. Various schemes have been adopted for concatenating tributary units to accommodate ETHERNET traffic over the SONET network.

SONET signals and ETHERNET signals are fundamentally different. A SONET signal is a continuous stream of data transmitted at a constant rate. An ETHERNET signal is a discontinuous stream of packets (also referred to as frames) of varying size which are generated at varying rates. There are times when ETHERNET packets are generated faster than they can be transmitted. In order to prevent loss of data, buffers are provided at the data sources. Packets which cannot be immediately transmitted are stored in the buffer until bandwidth becomes available. In addition to bandwidth issues, there are times when a source of data generates packets faster than the data sink can process the data. In order to prevent loss of data in these circumstances, buffers are provided at the data sinks to store incoming packets awaiting processing. In addition to the provision of buffers, ETHERNET establishes a method of flow control whereby the data sink can signal the data source to stop (XOFF) and start (XON) transmitting packets. This flow control signaling is a well defined PAUSE frame which is illustrated in prior art FIG. 1.

The destination address (DA) of the PAUSE frame may be set to either the unique DA of the source to be paused, or to the globally assigned multicast address 01-80-C2-00-00-01 (hex). This multicast address has been reserved by the IEEE 802.3 standard for use in MAC (Media Access Control) PAUSE frames.

The “Type” field of the PAUSE frame is set to 88-08 (hex) to indicate the frame is a MAC Control frame.

The MAC Control opcode field is set to 00-01 (hex) to indicate the type of MAC Control frame being used is a PAUSE frame. The PAUSE frame is the only type of MAC Control frame currently defined.

The MAC Control Parameters field contains a 16-bit value that specifies the duration of the PAUSE event in units of 512-bit times. Valid values are 00-00 to FF-FF (hex). If an additional PAUSE frame arrives before the current PAUSE time has expired, its parameter replaces the current PAUSE time. A PAUSE frame with parameter zero allows transmission to resume immediately.

A 42-byte reserved field (transmitted as all zeros) is required to pad the length of the PAUSE frame to the minimum ETHERNET frame size.

A device used to encapsulate ETHERNET packets within SONET tributaries is called a mapper and a device used to decapsulate ETHERNET packets from SONET tributaries is called a demapper. Typically, mappers and demappers are combined into a single device called a mapper. It is desirable to provide the mapper with local flow control (L-FC) so that the local source of ETHERNET packets which are being mapped by the mapper into SONET tributaries can be paused to prevent mapper buffers from overflowing. However, the local source of ETHERNET packets must also be responsive to PAUSE frames from the distant sink, end-to-end flow control (EE-FC). This naturally provides the potential for a conflict. For example, if the local ETHERNET device is in the paused mode after receiving a locally generated PAUSE frame and a remotely generated PAUSE frame, an XON PAUSE frame (either locally generated or remotely generated) may cause the local ETHERNET device to resume transmitting prematurely. This will result in a loss of data either locally (in the case of a remotely generated XON overriding the locally generated XOFF) or remotely (in the case of a locally generated XON overriding the remotely generated XOFF)

### SUMMARY OF THE INVENTION

It is therefore an object of the invention to provide both local and end-to-end flow control when encapsulating and decapsulating ETHERNET frames over SONET.

It is another object of the invention to prevent local and end-to-end flow control from interfering with each other.

In accord with these objects, which will be discussed in detail below, whenever a PAUSE frame is generated locally, a pause refresh timer is set with the pause parameter from the PAUSE frame. PAUSE frames which are received from a remote data sink are trapped and the value of the pause parameter is evaluated. If the value is smaller than the current pause refresh timer value, the pause frame is discarded. If the value is equal to or larger than the current pause refresh timer value, the PAUSE frame is passed on to the data source and an end-to-end flow control (EEFC) timer is set with the pause parameter received from the remote data sink. While the EEFC timer is counting down, locally generated PAUSE frames having a pause parameter less than the timer value are suppressed.

The invention is optionally embodied in a bidirectional gigabit ETHERNET SONET mapper where local PAUSE frames are generated on the transmit side. Each gigabit ETHERNET port is provided with a FIFO, two programmable watermark registers, a PAUSE frame timer register, a pause refresh timer, and an EEFC timer. One watermark register is programmed with the FIFO fullness value which triggers a local XOFF PAUSE frame and the other is programmed with the FIFO fullness value which triggers a local XON PAUSE frame. The PAUSE frame timer register is programmed with the value which is loaded into the pause refresh timer when a local XOFF PAUSE frame is generated. This value is also used as the pause parameter in the locally generated XOFF PAUSE frame. The EEFC timer is loaded with the pause parameter obtained from XOFF PAUSE frames received from the remote data sink. According to the presently preferred embodiment, the pause refresh timer may be controlled to generate a PAUSE frame after it has completely counted down or 75% counted down. The 75% setting allows more margin for congestion relief, e.g. in cases of network latency.

Additional objects and advantages of the invention will become apparent to those skilled in the art upon reference to the detailed description taken in conjunction with the provided figures.

### BRIEF DESCRIPTION OF THE DRAWINGS

FIG. 1 is a prior art diagram of an ETHERNET PAUSE frame;

FIG. 2 is a schematic block diagram of an apparatus suitable for practicing the methods of the invention; and

FIG. 3 is a flow chart illustrating the methods of the invention.

### DETAILED DESCRIPTION OF THE PREFERRED EMBODIMENTS

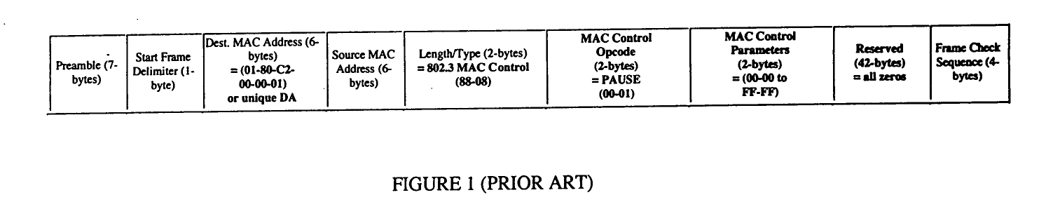

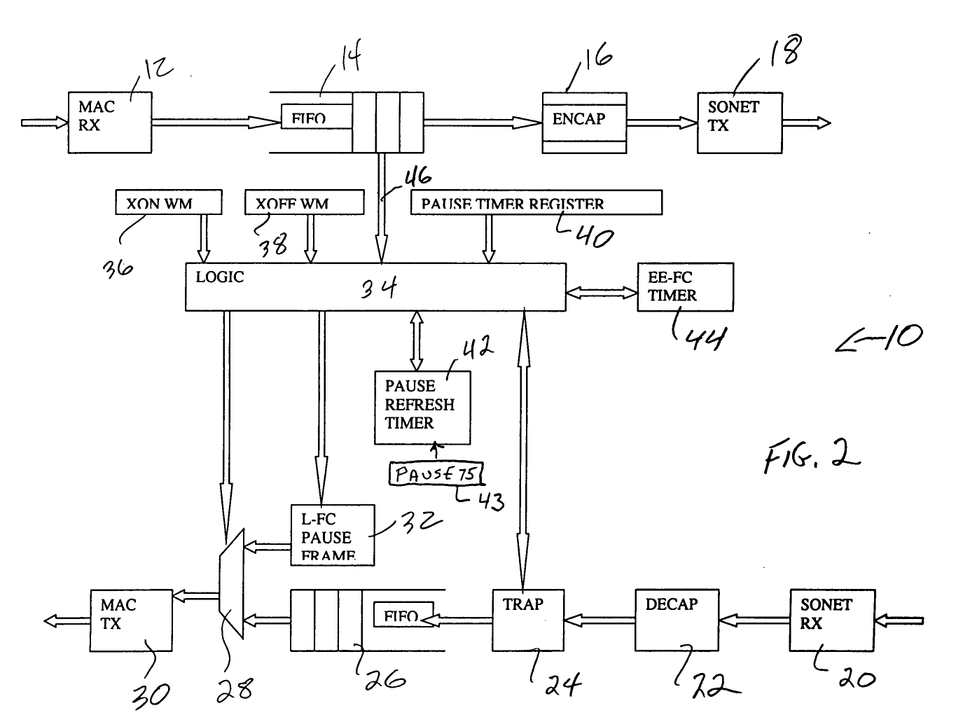

The methods of the invention are advantageously implemented within an ETHERNET-SONET mapper/demapper which typically will map/demap multiple ETHERNET ports over a single SONET signal. FIG. 2 is a high level block diagram of the components of a mapper/demapper for one ETHERNET port. Thus, the apparatus 10 of FIG. 1 includes an ETHERNET MAC receiver 12 which receives ETHERNET packets. Packets from the receiver 12 are fed into a transmit FIFO 14 to await transmission via the SONET signal. Packets exiting the FIFO 14 are received by an encapsulation circuit 16 which maps the packets into SONET tributaries. The SONET tributaries are transmitted by a SONET transmitter 18. In the reverse direction of flow, a SONET receiver 20 receives SONET signals. ETHERNET packets are decapsulated from the signals by a decapsulation circuit 22. According to one aspect of the invention, the decapsulated ETHERNET packets are fed through a trap 24 before flowing into a receive FIFO 26. The trap 24 is designed to identify and, optionally delete, incoming PAUSE frames as described in more detail below in order to prevent the remotely generated PAUSE frame from overriding a locally generated PAUSE frame. According to another aspect of the invention, packets exiting the FIFO 26 are fed through a multiplexer 28 before reaching an ETHERNET MAC transmitter 30. The multiplexer 28 is controlled, as described below, to interpose a local PAUSE frame 32 in the stream of packets flowing to the MAC transmitter 30.

According to the illustrated embodiment, logic 34 is provided for controlling the trap 24 and the multiplexer 28. The logic 34 is associated with three registers 36, 38, 40, two timers 42, 44, and a transmit FIFO fullness indication 46. The registers are programmable via a processor port (not shown) on the mapper/demapper of which the apparatus 10 is a part. The XON watermark register 36 is used to store the FIFO fullness value which will trigger a local XON PAUSE frame. Similarly, the XOFF watermark register 38 is used to store the FIFO fullness value which will trigger a local XOFF PAUSE frame. The pause timer register 40 is used to store the pause parameter which is used in the local XOFF PAUSE frame. The pause refresh timer 42 is a count down timer which is loaded with the value from the pause refresh register 40 when a local XOFF PAUSE frame is passed through the multiplexer 28 to the MAC transmitter 30. The EE-FC timer 44 is a count down timer which is loaded with the PAUSE parameter obtained from a PAUSE frame detected in the trap 24 and passed to the FIFO 26. The FIFO fullness measure 46 indicates the fullness of the transmit FIFO 14 and is used by the logic 34 in conjunction with the values from the watermark registers 36 and 38 to determine when a local PAUSE frame might be sent to the MAC transmitter 30. As described briefly above, a local PAUSE frame will not be generated unless the pause parameter of the frame is greater than or equal to the pause time remaining on the EE-FC timer 44. This will prevent locally generated PAUSE frames from prematurely shortening PAUSE times set by remotely generated PAUSE frames. Similarly, a PAUSE frame caught in the trap 24 will be deleted unless its pause parameter is greater than or equal to the time remaining in the pause refresh timer 42. This will prevent remotely generated PAUSE frames from prematurely shortening PAUSE times set by locally generated PAUSE frames. In other words, the PAUSE frame with the longest pause time is always selected to be sent to the local ETHERNET device.

According to the presently preferred embodiment, the pause refresh timer may be controlled to generate a PAUSE frame after it has completely counted down or 75% counted down. This 75% setting allows more margin for congestion relief, e.g. in cases of network latency. As shown in FIG. 2, a pause75 signal 43 may be applied to the timer 42 which causes the PAUSE frame to be generated after the timer has counted down to 75% of its value. It will be appreciated that the 75% feature can be achieved in different ways. For example, it can be achieved by reducing the value of the pause refresh timer by 25% when it is loaded, or by indicating to the logic 34 that the timer should be considered expired when 75% of its set value has counted down.

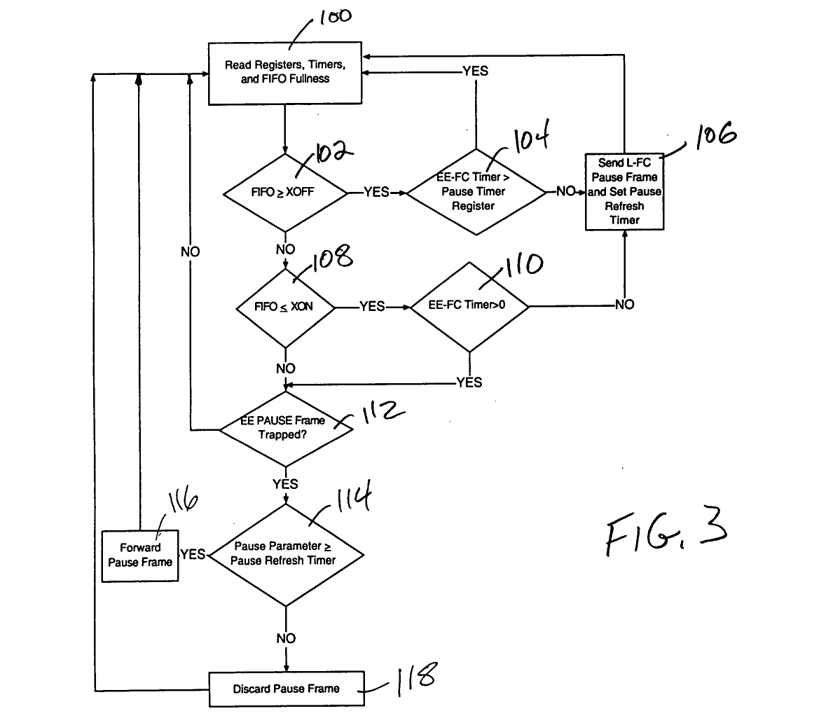

FIG. 3 illustrates an implementation of the methods of the invention expressed as a flow chart. Reference will also be made to FIG. 2 while describing FIG. 3. Starting at 100 in FIG. 3, the logic circuit 34 (FIG. 2) reads the registers 36, 38, 40, the timers 42, 44, and the FIFO fullness 46.

At 102, the FIFO fullness 46 is compared to the value read from the XOFF watermark register 38. If the fullness is greater than or equal to the XOFF value, the logic then determines at 104 whether the count read from the end-to-end flow control timer 44 is greater than the value read from the pause timer register 40. If the count read from the end-to-end flow control timer is not greater, a local XOFF PAUSE frame 32 is generated, the pause refresh timer 42 is loaded with the value read from the pause timer register 40, and the multiplexer 28 is controlled to send the PAUSE frame 32 to the MAC transmitter 30, all of which is indicated at 106 in FIG. 3. If the count read from the end-to-end flow control timer 44 is greater than the value read from the pause timer register 40, no local PAUSE frame is sent and the process returns to 100.

If the fullness is less than the XOFF value, as determined at 102, the FIFO fullness 46 is compared at 108 to the value read from the XON watermark register 36. If FIFO fullness is less than or equal to the XON value, the logic 34 determines at 110 whether EE-FC timer 44 is still counting down. If the timer 44 has expired (i.e. the timer is not >0), a local XON PAUSE frame 32 is generated, the pause refresh timer 42 is set to zero, and the multiplexer 28 is controlled to send the PAUSE frame 32 to the MAC transmitter 30, all of which is indicated at 106 in FIG. 3.

If the EE-FC timer 44 is still counting down as determined at 110 or if the FIFO fullness is greater than the XON value as determined at 108, the logic determines at 112 whether a PAUSE frame generated by the remote data sink has been trapped in the trap 24. If no PAUSE frame is in the trap, the process returns to 100. If a PAUSE frame has been received, its pause parameter is compared at 114 to the reading from the pause refresh timer 42. If the pause parameter is greater than or equal to the reading from the pause refresh timer 42, the PAUSE frame is released from the trap 24 to be forwarded at 116 to the MAC transmitter 30 and the process returns to 100. If the pause refresh timer 42 contains a count which is higher than the pause parameter in the trapped PAUSE frame, the trapped frame is discarded at 118 and the process returns to 100.

There have been described and illustrated herein methods and apparatus for pause frame reconciliation in end-to-end and local flow control for ETHERNET over SONET. While particular embodiments of the invention have been described, it is not intended that the invention be limited thereto, as it is intended that the invention be as broad in scope as the art will allow and that the specification be read likewise. Thus, while an exemplary circuit has been disclosed, it will be appreciated that other software, hardware, or firmware means can be used to perform substantially the same function. In addition, while the methods have been described with reference to a sequence of steps in a flow chart, it will be understood that the steps can be performed in a different sequence while achieving the same results. Moreover, the process described with reference to FIG. 3 could be event driven through the use of interrupts and thus the order of the method steps would change from time to time. Furthermore, the act of discarding a PAUSE frame can be accomplished in several different ways, e.g.: by failing to write the frame to the FIFO, by overwriting the frame after it has been written to the FIFO, or by not reading the frame from the FIOF. It will therefore be appreciated by those skilled in the art that yet other modifications could be made to the provided invention without deviating from its spirit and scope as claimed.

What is claimed is:

1. A method for reconciling locally generated and remotely generated ETHERNET PAUSE frames, comprising:
when a PAUSE frame is generated locally, setting a pause refresh timer with the pause parameter of the locally generated PAUSE frame;
trapping a remotely generated PAUSE frame when it is received;
comparing the pause parameter of the trapped remotely generated PAUSE frame with the pause refresh timer; and
discarding the remotely generated PAUSE frame if the pause refresh timer value is greater than the pause parameter of the remotely generated PAUSE frame.

2. The method according to claim 1, further comprising:
releasing the trapped remotely generated PAUSE frame if the pause parameter of the remotely generated PAUSE frame is greater than or equal to the pause refresh timer value.

3. The method according to claim 2, further comprising:
setting a flow control timer with the pause parameter of the remotely generated PAUSE frame when the remotely generated PAUSE frame is released.

4. The method according to claim 3, further comprising:
suppressing locally generated PAUSE frames which have a pause parameter value less than the value of the flow control timer.

5. The method according to claim 1, further comprising:
reducing the value of the value of the pause parameter in the pause refresh timer by a predetermined percentage.

6. The method according to claim 5, wherein:
said percentage is approximately 25%.

7. An apparatus for reconciling locally generated and remotely generated ETHERNET PAUSE frames, each having pause parameters, comprising:
a pause refresh timer set with the pause parameter of the locally generated PAUSE frame;
a trap for trapping a remotely generated PAUSE frame when it is received;
a comparator for comparing the pause parameter of the remotely generated PAUSE frame with the pause refresh timer; and
logic which prevents the remotely generated PAUSE frame from reaching its destination if the pause refresh timer value is greater than the pause parameter of the remotely generated PAUSE frame.

8. The apparatus according to claim 7, further comprising:
logic which allows the trapped remotely generated PAUSE frame to continue to its destination if the pause parameter of the remotely generated PAUSE frame is greater than or equal to the pause refresh timer value.

9. The apparatus according to claim 8, further comprising:
a flow control timer set with the pause parameter of the remotely generated PAUSE frame when the remotely generated PAUSE frame is released.

10. The apparatus according to claim 9, further comprising:
logic which suppresses locally generated PAUSE frames which have a pause parameter value less than the value of the flow control timer.

11. The apparatus according to claim 7, further comprising:
logic which reduces the value of the pause parameter set in the pause refresh timer by a predetermined percentage.

12. The apparatus according to claim 11, wherein:
said percentage is approximately 25%.

13. An apparatus for reconciling locally generated and remotely generated ETHERNET PAUSE frames, each having pause parameters, comprising:
a pause refresh timer means for counting down from the pause parameter of the locally generated PAUSE frame;
a trap means for trapping a remotely generated PAUSE frame when it is received;
a comparator means for comparing the pause parameter of the remotely generated PAUSE frame with the pause refresh timer; and
logic means for preventing the remotely generated PAUSE frame from reaching its destination if the pause refresh timer value is greater than the pause parameter of the remotely generated PAUSE frame.

14. The apparatus according to claim 13, further comprising:
logic means for allowing the trapped remotely generated PAUSE frame to continue to its destination if the pause parameter of the remotely generated PAUSE frame is greater than or equal to the pause refresh timer value.

15. The apparatus according to claim 14, further comprising:
a flow control timer means for counting down from the pause parameter of the remotely generated PAUSE frame when the remotely generated PAUSE frame is released.

16. The apparatus according to claim 15, further comprising:
logic means for suppressing locally generated PAUSE frames which have a pause parameter value less than the value of the flow control timer.

17. The apparatus according to claim 13, further comprising:
logic means for reducing the value of the pause parameter set in the pause refresh timer by a predetermined percentage.

18. The apparatus according to claim 17, wherein:
said percentage is approximately 25%.
